(19) United States
(12) Patent Application Publication
(10) Pub. No.: US 2009/0136681 A1
(43) Pub. Date: May 28, 2009

(54) Phase Change Curable Inks

(75) Inventors: Jennifer L. Belelie, Oakville (CA); Peter G. Odell, Mississauga (CA); Christopher A. Wagner, Etobicoke (CA); C. Geoffrey Allen, Waterdown (CA)

Correspondence Address: OLIFF & BERRIDGE, PLC., P.O. BOX 320850, ALEXANDRIA, VA, 22320-4850, US

(73) Assignee: XEROX CORPORATION, Norwalk, CT (US)

(21) Appl. No.: 11/946,348

(22) Filed: Nov. 28, 2007

(51) Int. Cl. B05D 3/06; C08F 22/20; C08K 5/20

(52) U.S. Cl. 427/532; 524/218; 526/320

(57) ABSTRACT

A variety of UV curable phase change inks are disclosed. The inks possess the characteristic the gloss of printed areas closely matches the gloss of unprinted areas of the substrate. On plain papers the printed and unprinted gloss values are within 5 ggu when measured at 60°. On coated papers, the printed and unprinted gloss values are within 25 ggu when measured at 60°. Although not limited by any theory, it is speculated that the gel rheology of inks of the disclosure conforms well with the paper substrate, providing a rougher low gloss surface on plain paper and a smoother high gloss surface on coated paper.

### TECHNICAL FIELD

This disclosure is generally directed to curable inks, such as curable phase change inks, and their use in methods for forming images, such as their use in ink jet printing. More particularly, this disclosure is directed to radiation curable inks, such as ultraviolet light curable phase change inks, having the properties that the gloss of printed areas closely matches the gloss of unprinted areas on a substrate.

### BACKGROUND

In many applications it is desirable for the gloss of the printed image to match that of unprinted areas of the substrate. Thus, a desired property of inks is that the gloss of printed areas closely matches the gloss of unprinted areas of the substrate.

After an image is printed on a substrate, it exhibits a distinctive reflection characteristic commonly referred to as gloss. The unprinted surface of the substrate itself also exhibits a unique gloss. The quality of the image formed on a substrate depends on a number of factors, including the surface characteristics of the substrate itself. Various substrates may be used in the printing process including, but not limited to, letter quality paper, envelopes, photographic print stock, transparencies and the like. Some substrates have a finish on the surface thereof which is glossy (e.g., transparencies and photographic print stock) while other substrates have a finish which is matte (e.g., envelopes and letter quality paper). The terms “glossy” and “matte” refer generally to the amount of light which is reflected from the surface of the substrate when it is illuminated by a light source, with glossy substrates reflecting more light than matte media substrates.

Typically, the suitable standard for measuring gloss is described as directing a light beam at a sample (substrate), blocking the specular beam and only detecting the diffused light around it with a conventional light sensor. There are three prominent standards that describe the measurement of gloss: the German DIN 67530, the International ISO/DIS 2813/8254, and ASTM D 523. From the experimental setup, they differ slightly, but essentially, they are based on a few fundamental principles. Gloss by definition is measured in reflection geometry. When a sample is very smooth and reflects well (which is equivalent to high gloss) most reflected light is contained within the direct specular beam while only a small part of the intensity is reflected as a diffused light. The ratio of specular to diffuse light varies with the gloss. When most light is reflected diffusely, the sample is perceived as low gloss (matte).

Printing devices use a printing composition (e.g., ink or toner) to print text, graphics, images and the like onto a media substrate.

One option for controlling the gloss level of a substrate during the printing process is to manually adjust the printing device in accordance with the determined gloss level. Commonly adjusted printing parameters include the temperature of the fuser rollers and the fuser pressure. If the gloss level of the media substrate is high, the temperature of the fuser rollers may be increased and/or the fuser pressure increased to produce a glossy image thereon. Alternatively, if the gloss level of the media substrate is low, the temperature of the fuser rollers may be decreased and/or the fuser pressure decreased to produce a matte image. Exactly how high the temperature or how the pressure of the rollers is to be adjusted is generally predetermined and stored in the printer controller with certain parameters corresponding to certain media types; the media types also being predetermined and stored as discussed with the prior art methods, above.

Ink jetting devices are known in the art, and thus extensive description of such devices is not required herein. As described in U.S. Pat. No. 6,547,380, incorporated herein by reference, ink jet printing systems are generally of two types: continuous stream and drop-on-demand. In continuous stream ink jet systems, ink is emitted in a continuous stream under pressure through at least one orifice or nozzle. The stream is perturbed, causing it to break up into droplets at a fixed distance from the orifice. At the break-up point, the droplets are charged in accordance with digital data signals and passed through an electrostatic field that adjusts the trajectory of each droplet in order to direct it to a gutter for recirculation or a specific location on a recording medium. In drop-on-demand systems, a droplet is expelled from an orifice directly to a position on a recording medium in accordance with digital data signals. A droplet is not formed or expelled unless it is to be placed on the recording medium.

There are three types of drop-on-demand ink jet systems. One type of drop-on-demand system is a piezoelectric device that has as its major components an ink filled channel or passageway having a nozzle on one end and a piezoelectric transducer near the other end to produce pressure pulses. Another type of drop-on-demand system is known as acoustic ink printing. As is known, an acoustic beam exerts a radiation pressure against objects upon which it impinges. Thus, when an acoustic beam impinges on a free surface (i.e., liquid/air interface) of a pool of liquid from beneath, the radiation pressure which it exerts against the surface of the pool may reach a sufficiently high level to release individual droplets of liquid from the pool, despite the restraining force of surface tension. Focusing the beam on or near the surface of the pool intensifies the radiation pressure it exerts for a given amount of input power. Still another type of drop-on-demand system is known as thermal ink jet, or bubble jet, and produces high velocity droplets. The major components of this type of drop-on-demand system are an ink filled channel having a nozzle on one end and a heat generating resistor near the nozzle. Printing signals representing digital information originate an electric current pulse in a resistive layer within each ink passageway near the orifice or nozzle, causing the ink vehicle (usually water) in the immediate vicinity to vaporize almost instantaneously and create a bubble. The ink at the orifice is forced out as a propelled droplet as the bubble expands.

In a typical design of a piezoelectric ink jet device, the image is applied by jetting appropriately colored inks during four to six rotations (incremental movements) of a substrate (an image receiving member or intermediate transfer member) with respect to the ink jetting head, i.e., there is a small translation of the printhead with respect to the substrate in between each rotation. This approach simplifies the printhead design, and the small movements ensure good droplet registration. At the jet operating temperature, droplets of liquid ink are ejected from the printing device and, when the ink droplets contact the surface of the recording substrate, either directly or via an intermediate heated transfer belt or drum, they quickly solidify to form a predetermined pattern of solidified ink drops.

Hot melt inks typically used with ink jet printers have a wax based ink vehicle, e.g., a crystalline wax. Such solid ink jet inks provide vivid color images. In typical systems, these crystalline wax inks partially cool on an intermediate transfer member and are then pressed into the image receiving medium such as paper. Transfuse spreads the image droplet, providing a richer color and lower pile height. The low flow of the solid ink also prevents show through on the paper.

In these systems, the crystalline wax inks are jetted onto a transfer member, for example, an aluminum drum, at temperatures of approximately 120-140° C. The wax based inks are heated to such high temperatures to decrease their viscosity for efficient and proper jetting onto the transfer member. The transfer member is at approximately 60° C., so that the wax will cool sufficiently to solidify or crystallize. As the transfer member rolls over the recording medium, e.g., paper, the image comprised of wax based ink is pressed into the paper.

However, the use of crystalline waxes places limitations on the printing process. First, the printhead must be kept at about 130° C. during the print process. Moreover, when the printhead is cooled and re-warmed, the resulting contraction and expansion of the ink requires a purge cycle to achieve optimum printhead performance. Furthermore, increased mechanical robustness is desired.

While known compositions and processes are suitable for their intended purposes, a need remains for improvements in hot melt inks, for example with respect to jetting temperatures, fusing latitude, and image quality, including low gloss image properties, high gloss image properties, and matching gloss properties.

Conventional UV curable inks generally provide very high gloss images. These high gloss images are very attractive in pictorial applications and on high gloss substrates. However, market experience shows that some users prefer matte or lower gloss images, such as for text and highlight color applications, and especially on low gloss substrates. UV curable inks and films tend to have high gloss values, such as about 80 ggu (Gardner Gloss Units) or higher, as measured at 75° by the GARDNER® gloss unit. However, many business applications require or prefer a lower gloss value, such as about 20 to about 50 ggu (Gardner Gloss Units). See, for example, Dalal & Swanton, TAGA Proceedings 1996, pp. 195-205 (1996).

Standard gloss reduction techniques include incorporation of particles of silica or alumina, and complex illumination schemes to selectively cure different film depths. However, such approaches are not suitable for high speed ink jet processes, as the particle size (about 25 microns) is generally too large and the resultant film is generally too thin to effectively use a dual cure scheme to generate surface irregularities and reduce gloss.

Thus, there is a need in the art for ink having the properties that the gloss of printed areas on a substrate closely matches the gloss of unprinted areas on a substrate.

### REFERENCES

U.S. Pat. Nos. 5,804,671, 5,889,076, 6,239,189 and 6,316.517, as well as U.S. Publication No. 2003/0036587, each disclose compositions including rheology modifying agents therein. U.S. Pat. No. 5,804,671 and U.S. Pat. No. 5,889,076 describe a composition that is useful in the preparation of radiation curable coatings and comprising the reaction product of an epoxy component and an acid component comprised of an ethylenically unsaturated carboxylic acid or reactive derivative thereof, reacted in the presence of, or post-reaction blended with, a polyamide based on a polymerized fatty acid and having a number average molecular weight of less than about 10,000 g/mole. U.S. Pat. No. 6,239,189 describes a radiation-polymerizable composition that may be included in a printing ink, the composition containing at least one curable acrylate resin oligomer prepared by reacting an alkoxylated polyol with a first acid component which includes an ethylenically unsaturated carboxylic acid, and a rheology modifier prepared by reacting a diepoxide with a second acid component which includes an ethylenically unsaturated carboxylic acid or reactive derivative thereof in the presence of a polyamide based on a polymerized fatty acid. Ink jet inks and/or phase change inks are not described, and in fact it is believed that the viscosities of the inks described in this reference would be so large that such inks could not be jetted. U.S. Pat. No. 6,316,517 describes radiation polymerizable compositions that are especially useful as or in a flush vehicle for making flushed pigments. The compositions contain at least one radiation curable acrylated resin component and a copolymerizable rheology modifier component. In particular, the flushed pigment comprises a pigment and a flushing vehicle, the flushing vehicle comprising a substantially homogenous admixture of two or more curable acrylated resins selected from the group consisting of acrylated epoxies, acrylated urethanes and acrylated polyesters, and a rheology modifying resin copolymerizable with curable acrylate resin when subjected to radiation in the presence of a photoinitiator, for example the reaction product of (i) an epoxy component, (ii) an ethylenically unsaturated carboxylic acid or reactive derivative thereof and (iii) a fatty acid or reactive derivative thereof, said components tip (ii) and (iii) being reacted in the presence of a polyamide based on a polymerized fatty acid. U.S. Publication No. 2003/0036587 describes a rheology controlled epoxy composition capable for use in bonding a silicon substrate to a flex circuit or a flex circuit to a pen body, comprising: (a) an epoxy resin component; (b) a rheology control agent selected from the group consisting of epoxysilanes, aminosilanes, trialkoxysilyl isocyanurate derivatives, and combinations thereof; (c) a curing agent component comprising a member selected from the group consisting of amine compounds, amide compounds, imidazole compounds, and combinations thereof; and (d) optionally, an inorganic filler component.

U.S. Pat. No. 6,586,492 describes an inkjet ink comprising an ink jet vehicle and a colorant, the vehicle comprising at least 35% by weight, based on the total vehicle weight, of a radiation curable material and further comprising a thickener, said vehicle being a thixotropic paste at 20° C., and said vehicle having a viscosity of less than 25 centipoise at least at one temperature in the range of from 40° C. to 130° C.

U.S. Pat. No. 5,892,116 and PCT Patent Publication WO 97/24364, disclose gellants that gel a variety of nonpolar and polar liquids. Moreover, gelation of various monomers with subsequent polymerization of the gelled monomers forms organic zeolites and membrane materials.

U.S. Pat. No. 7,046,364, discloses a method and apparatus for matching the gloss level of a printed region of a media substrate surface to the gloss level of a non-printed region of the media substrate.

U.S. Pat. No. 6,819,886, discloses an on-line gloss/density meter for an electrostatographic reproduction apparatus in which pigmented marking particle images are fixed to receiver members respectively by application of heat and/or pressure as such receiver members travel along a transport path through a fuser assembly.

Commonly assigned, U.S. Patent Publication No. 2007/0142492, discloses ultraviolet light curable phase change inks that comprise a curable monomer or oligomer, a curable wax, an optional colorant, and an optional radiation-activated initiator that initiates polymerization of the curable monomer or oligomer and the curable wax.

The disclosures of each of the foregoing patents and publications are hereby incorporated by reference herein in their entireties. The appropriate components and process aspects of the each of the foregoing patents and publications may also be selected for the present compositions and processes in embodiments thereof.

### SUMMARY

A variety of UV curable phase change inks have been developed. A desired property of these inks is that the gloss of printed areas closely matches the gloss of unprinted areas of the substrate.

In one embodiment of the disclosure, the ink possesses the properties that on plain paper, such as Xerox 4024 and Hammermill papers, the printed and unprinted gloss values are within 5 ggu when measured at 600.

In another embodiment of the disclosure, the ink possesses the properties that on coated paper, such as Xerox Digital Color and Pasadena Litho Label coated papers, the printed and unprinted gloss values are within 25 ggu when measured at 60°.

### EMBODIMENTS

The inks disclosed herein possess the characteristic that gloss of printed areas closely matches the gloss of unprinted areas of the substrate. On plain papers the printed and unprinted gloss values are within 5 ggu when measured at 60°. On coated papers, the printed and unprinted gloss values are within 25 ggu when measured at 60°. Although not limited by any theory, it is speculated that the gel rheology of inks of the disclosure conforms well with the paper substrate, providing a rougher low gloss surface on plain paper and a smoother high gloss surface on coated paper.

All gloss (ggu) values herein are measured using ASTM D 523, at 60°, unless otherwise noted. The entire disclosure of ASTM4 D 523 is incorporated herein by reference, All gloss measurements were made on a micro-TRI-gloss meter from BYK Gardner at 60° The print samples were placed directly beneath the glossmeter and three gloss measurements were taken within a 75×150 mm area. The mean gloss values were recorded.

On plain paper, the inks disclosed herein exhibit closely matched gloss values between the printed image and unprinted portions of the substrate, where the gloss values are within about 5 ggu of each other, with the printed image having either higher or lower gloss than the unprinted portions of the substrate. In embodiments, the gloss values are within about 4 ggu, about 3 ggu, about 2 ggu, or about 1 ggu of each other, with the printed image having either higher or lower gloss than the unprinted portions of the substrate, although generally the gloss of the printed image is higher than the gloss of unprinted portions of the paper.

As used herein, “plain paper” refers, for example, to paper without a surface treatment or coatings Gloss measurements are typically reserved for papers with coatings (see discussion below). Examples of such plain paper include XEROX® 4024 papers, XEROX® Image Series papers, Courtland 4024 DP paper, ruled notebook paper, bond paper. HAMMERMILL LASERPRINT® paper, and the like.

On coated paper, the inks disclosed herein also exhibit closely matched gloss values between the printed image and unprinted portions of the substrate, where the gloss values are within about 25 ggu of each other, with the printed image having either higher or lower gloss than the unprinted portions of the substrate. In embodiments, the gloss values are within about 20 ggu, about 18 ggu, about 15 ggu, or about 10 ggu of each other, with the printed image having either higher or lower gloss than the unprinted portions of the substrate, although generally the gloss of the printed image is higher than the gloss of unprinted portions of the paper.

As used herein, “coated paper” refers, for example, to paper that is surface treated with a substance to change at least one surface property of the paper, including gloss, smoothness, ink adhesion, etc. One or both sides of the paper can be surface treated. Coated papers can be classified according to the measured gloss range at 75°: “high gloss” refers to gloss values over 80 ggu, “gloss” ranges from 50-80 ggu, “semi-gloss” ranges from 35-50 ggu, “satin or velvet gloss” ranges from 25-35 ggu and “matte” ranges from 10-25 ggu (reference: Tamara D. Pope and Gilles Biscos, The Guide to Paper and Digital Printing: What You Should Know, 3^{rd} Ed. (2007), Interquest, Ltd., Charlottesville (VA)). Examples of such coated paper include XEROX® Digital Color Gloss, Sappi Warren Papers LUSTROGLOSS®₇. Pasadena Litho Label paper, and the like.

It will be appreciated that various of the above-disclosed and other features and functions, or alternatives thereof, may be desirably combined into many other different systems or applications. Also, various presently unforeseen or unanticipated alternatives, modifications, variations or improvements therein may be subsequently made by those skilled in the art, and are also intended to be encompassed by the following claims.

The coin position of the present disclosure is a curable ink, such as a radiation (such as UV-light) curable ink. In embodiments, the radiation curable ink comprises a curable monomer or oligomer, such as one that is liquid at 25° C., a gellant, and a colorant. In embodiments, the composition of the present disclosure can also include a curable wax, such as a curable waxy acrylate, and other optional additives.

The term “curable” refers, for example, to the component or combination being polymerizable, that is, a material that may be cured via polymerization, including for example free radical routes, and/or in which polymerization is photoinitiated though use of a radiation sensitive photoinitiator.

Thus, for example, the term “radiation curable” is intended to cover all forms of curing upon exposure to a radiation source, including light and heat sources and including in the presence or absence of initiators. Example radiation curing routes include, but are not limited to, curing using ultraviolet (UV) light, for example having a wavelength of 200-400 nm or more rarely visible light, such as in the presence of photoinitiators and/or sensitizers, curing using e-beam radiation, such as in the absence of photoinitiators, curing using thermal curing, in the presence or absence of high temperature thermal initiators (and which are generally largely inactive at the jetting temperature), and appropriate combinations thereof.

In the uncured state, the composition in embodiments is a low viscous liquid and is readily jettable at a temperature between 60 and 100° C. Upon exposure to a suitable source of curing energy, e.g., ultraviolet light, electron beam energy, or the like, the photoinitiator absorbs the energy and sets into motion a reaction that converts the liquid composition into a cured material. The monomer and/or oligomer in the composition contain functional groups that polymerize during exposure to the curing source to readily crosslink forming a polymer network. This polymer network provides printed image with, for example, durability, thermal and light stability, and scratch and smear resistance. Thus, the composition is particularly well-suited for ink-based images printed on substrates that may be subjected to heat or sunlight, because the composition provides a printed image that is resistant to cracking and fading and provides image permanence.

Suitable radiation, such as UV, curable monomers and oligomers include, but are not limited to, acrylated esters, acrylated polyesters, acrylated ethers, acrylated polyethers, acrylated epoxies, urethane acrylates, and pentaerythritol tetraacrylate. Specific examples of suitable acrylated monomers include monoacrylates, diacrylates, and polyfunctional alkoxylated or polyalkoxylated acrylic monomers comprising one or more di- or tri-acrylates. Suitable monoacrylates are, for example, cyclohexyl acrylate, 2-ethoxy ethyl acrylate, 2-methoxy ethyl acrylate, 2-(2-ethoxyethoxy) ethyl acrylate, stearyl acrylate, tetrahydrofurfuryl acrylate, octyl acrylate, lauryl acrylate, behenyl acrylate, 2-phenoxy ethyl acrylate, tertiary butyl acrylate, glycidyl acrylate, isodecyl acrylate, benzyl acrylate, hexyl acrylate, isooctyl acrylate, isobornyl acrylate, butanediol monoacrylate, ethoxylated phenol monoacrylate, oxyethylated phenol acrylate, monomethoxy hexanediol acrylate, beta-carboxy ethyl acrylate, dicyclopentyl acrylate, carbonyl acrylate, octyl decyl acrylate, ethoxylated nonylphenol acrylate, hydroxyethyl acrylate, hydroxyethyl methacrylate, and the like. Suitable polyfunctional alkoxylated or polyalkoxylated acrylates are, for example, alkoxylated, such as ethoxylated or propoxylated, variants of the following: neopentyl glycol diacrylates, butanediol diacrylates, trimethylolpropane triacrylates, glyceryl triacrylates, 1,3-butylene glycol diacrylate, 1,4-butanediol diacrylate, diethylene glycol diacrylate, 1,6-hexanediol diacrylate, tetraethylene glycol diacrylate, triethylene glycol diacrylate, tripropylene glycol diacrylate, polybutanediol diacrylate, polyethylene glycol diacrylate, propoxylated neopentyl glycol diacrylate, ethoxylated neopentyl glycol diacrylate, polybutadiene diacrylate, and the like. In embodiments, one suitable monomer is a propoxylated neopentyl glycol diacrylate, such as, for example, SR-9003 (Sartomer Co., Inc., Exton, Pa.). Other suitable reactive monomers are likewise commercially available from, for example, Sartomer Co., Inc., Henkel Corp., Radcure Specialties, and the like. Specific examples of suitable acrylated oligomers include, but are not limited to, acrylated polyester oligomers, such as CN22562 (Sartomer Co.), EB 812 (Cytec Surface Specialties), EB 810 (Cytec Surface Specialties), CN2200 (Sartomer Co.), CN2300 (Sartomer Co., and the like, acrylated urethane oligomers, such as EB270 (UCB Chemicals), EB 5129 (Cytec Surface Specialties). CN2920 (Sartomer Co.), CN3211 (Sartomer Co.), and the like, and acrylated epoxy oligomers, such as EB 600 (Cytec Surface Specialties), EB 3411 (Cytec Surface Specialties), CN2204 (Sartomer Co.), CN 110 (Sartomer Co.), and the like: and pentaerythritol tetraacrylate oligomers, such as SR399LV (Sartomer Co.) and the like.

In embodiments, the at least one radiation curable monomer and/or oligomer can be cationically curable, radically curable, or the like.

The radiation curable monomer variously functions as a viscosity reducer, as a binder when the composition is cured, as an adhesion promoter, and as a crosslinking agent, for example. Suitable monomers can have a low molecular weight, low viscosity, and low surface tension and comprise functional groups that undergo polymerization upon exposure to radiation such as UV light in the presence of a suitable initiator.

In embodiments, the ink composition includes at least one reactive monomer and/or oligomer. However, other embodiments can include only one or more reactive oligomers, only one or more reactive monomers, or a combination of one or more reactive oligomers and one or more reactive monomers. However, in embodiments, the composition includes at least one reactive (curable) monomer, and optionally one or more additional reactive (curable) monomers and/or one or more reactive (curable) oligomers.

The curable monomer in embodiments is included in the ink in an amount of, for example, about 20 to about 90% by weight of the ink, such as about 30 to about 85% by weight of the ink, or about 40 to about 80% by weight of the ink. In embodiments, the curable monomer has a viscosity at 25° C. of about 1 to about 50 cP, such as about 1 to about 40 cP or about 5 to about 30 cP. In one embodiment, the curable monomer has a viscosity at 25° C. of about 20 cP. Also, in some embodiments, it is desired that the curable monomer is not a skin irritant.

The ink vehicles contain at least one compound that can exhibit gel-like behavior in that they undergo a relatively sharp increase in viscosity over a relatively narrow temperature range when dissolved in a liquid such as those compounds that behave as curable monomers when exposed to radiation such as ultraviolet light. One example of such a curable liquid monomer is a propoxylated neopentyl glycol diacrylate. In one embodiment, some vehicles as disclosed herein undergo a change in viscosity of at least about 10³ centipoise, in another embodiment at least about 10⁵ centipoise, and in yet another embodiment at least about 10⁶ centipoise over a temperature range of in one embodiment at least about 30° C. in another embodiment at least about 10° C., and in vet another embodiment at least about 5° C., although the viscosity change and temperature range can be outside of these ranges, and vehicles that do not undergo changes within these ranges are also included herein.

Any suitable gellant can be used for the ink vehicles disclosed herein. The gellant can be selected from materials disclosed in U.S. Pat. No. 7,279,687, entitled “Photoinitiator With Phase Change Properties and Gellant Affinity,” with the named inventors Peter G. Odell, Eniko Toma, and Jennifer L. Belelie, the disclosure of which is totally incorporated herein by reference, such as a compound of the formula

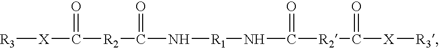

wherein:

R₁ is:

(i) an alkylene group (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphors, boron, and the like either may or may not be present in the alkylene group), in one embodiment with at least 1 carbon atom, and in one embodiment with no more than about 12 carbon atoms, in another embodiment with no more than about 4 carbon atoms, and in yet another embodiment with no more than about 2 carbon atoms, although the number of carbon atoms can be outside of these ranges.

(ii) an arylene group (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group), in one embodiment with at least about 5 carbon atoms, and in another embodiment with at least about 6 carbon atoms, and in one embodiment with no more than about 14 carbon atoms, in another embodiment with no more than) about 10 carbon atoms, and in yet another embodiment with no more than about 6 carbon atoms, although the number of carbon atoms can be outside of these ranges.

(iii) an arylalkylene group (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 7 carbon atoms, although the number of carbon atoms can be outside of these ranges, or

(iv) an alkylarylene group (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 7 carbon atoms, although the number of carbon atoms can be outside of these ranges, wherein the substituents on the substituted alkylene, arylene, arylalkylene, and alkylarylene groups can be (but are not limited to) halogen atoms, cyano groups, pyridine groups, pyridinium groups, ether groups, aldehyde groups, ketone groups, ester groups, amide groups, carbonyl groups, thiocarbonyl groups, sulfide groups, nitro groups, nitroso groups, acyl groups, azo groups, urethane groups, urea groups, mixtures thereof, and the like, wherein two or more substituents can be joined together to form a ring;

R₂ and R₂, each, independently of the other, are selected from the group consisting of:

(i) alkylene groups (wherein an alkylene group is defined as a divalent aliphatic group or alkyl group, including linear and branched, saturated and unsaturated, cyclic and acyclic, and substituted and unsubstituted alkylene groups, and wherein heteroatoms, such as oxygen, nitrogen, sulfur, silicon, phosphorus, boron, and the like either may or may not be present in the alkylene group), in one embodiment with at least 1 carbon atom, and in one embodiment with no more than about 54 carbon atoms, and in another embodiment with no more than about 36 carbon atoms, although the number of carbon atoms can be outside of these ranges,

(ii) arylene groups (wherein an arylene group is defined as a divalent aromatic group or aryl group, including substituted and unsubstituted arylene groups, and wherein heteroatoms, such as oxygen, nitrogen, sulfur, silicon, phosphorus, boron, and the like either may or may not be present in the arylene group), in one embodiment with at least about 5 carbon atoms, and in another embodiment with at least about 6 carbon atoms, and in one embodiment with no more than about 14 carbon atoms, in another embodiment with no more than about 10 carbon atoms, and in yet another embodiment with no more than about 7 carbon atoms, although the number of carbon atoms can be outside of these ranges,

(iii) arylalkylene groups (wherein an arylalkylene group is defined as a divalent arylalkyl group, including substituted and unsubstituted arylalkylene groups, wherein the alkyl portion of the arylalkylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 8 carbon atoms, although the number of carbon atoms can be outside of these ranges, or

(iv) alkylarylene groups (wherein an alkylarylene group is defined as a divalent alkylaryl group, including substituted and unsubstituted alkylarylene groups, wherein the alkyl portion of the alkylarylene group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylarylene group), in one embodiment with at least about 6 carbon atoms, and in another embodiment with at least about 7 carbon atoms, and in one embodiment with no more than about 32 carbon atoms, in another embodiment with no more than about 22 carbon atoms, and in yet another embodiment with no more than about 7 carbon atoms, although the number of carbon atoms can be outside of these ranges, wherein the substituents on the substituted alkylene, arylene, arylalkylene, and alkylarylene groups can be (but are not limited to) halogen atoms, cyano groups, ether groups, aldehyde groups, ketone groups, ester groups, amide groups, carbonyl groups, thiocarbonyl groups, phosphine groups, phosphonium groups, phosphate groups, nitrile groups, mercapto groups, nitro groups, nitroso groups, acyl groups, acid anhydride groups, azide groups, azo groups, cyanato groups, urethane groups, urea groups, mixtures thereof, and the like, wherein two or more substituents can be joined together to form a ring;

R₃ and R₃ each, independently of the other, are either:

(a) photoinitiating groups, such as groups derived from 1-(4-(2-hydroxyethoxy)phenyl)-2-hydroxy-2-methylpropan-1-one, of the formula

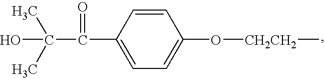

groups derived from 1-hydroxycyclohexylphenylketone, of the formula

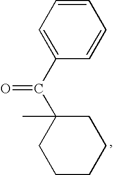

groups derived from 2-hydroxy-2-methyl-1-phenylpropan-1-one, of the formula

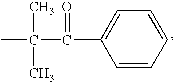

groups derived from N,N-dimethylethanolamine or N,N-dimethylethylenediamine, of the formula

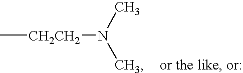

(b) a group which is:

(i) an alkyl group (including linear and branched, saturated and unsaturated, cyclic and acyclic, and substituted and unsubstituted alkyl groups, and wherein heteroatoms, such as oxygen, nitrogen, sulfur, silicon, phosphorus, boron, and the like either may or may not be present in the alkyl group), in one embodiment with at least about 2 carbon atoms, in another embodiment with at least about 3 carbon atoms, and in yet another embodiment with at least about 4 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges,

(ii) an aryl group (including substituted and unsubstituted aryl groups, and wherein heteroatoms, such as oxygen, nitrogen, sulfur, silicon, phosphorus, boron, and the like either may or may not be present in the aryl group), in one embodiment with at least about 5 carbon atoms, and in another embodiment with at least about 6 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, such as phenyl or the like,

(iii) an arylalkyl group (including substituted and unsubstituted arylalkyl groups, wherein the alkyl portion of the arylalkyl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the arylalkyl group), in or embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, such as benzyl or the like, or

(iv) an alkylaryl group (including substituted and unsubstituted alkylaryl groups, wherein the alkyl portion of the alkylaryl group can be linear or branched, saturated or unsaturated, and cyclic or acyclic, and wherein heteroatoms, such as oxygen, nitrogen, sulfur, silicon, phosphorus, boron, and the like either may or may not be present in either the aryl or the alkyl portion of the alkylaryl group), in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, such as tolyl or the like, wherein the substituents on the substituted alkyl, arylalkyl, and alkylaryl groups can be (but are not limited to) halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrite groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring:

provided that X and X′ each, independently of the other, is an oxygen atom or a group of the formula —NR₄—, wherein R₄ is:

(i) a hydrogen atom;

(ii) an alkyl group, including linear and branched, saturated and unsaturated, cyclic and acyclic, and substituted and unsubstituted alkyl groups, and wherein heteroatoms either may or may not be present in the alkyl group, in one embodiment with at least 1 carbon atom, and in one embodiment with no more than about 100 carbon atoms, in another embodiment with no more than about 60 carbon atoms, and in yet another embodiment with no more than about 30 carbon atoms, although the number of carbon atoms can be outside of these ranges,

(iii) an aryl group, including substituted and unsubstituted aryl groups, and wherein heteroatoms either may or may not be present in the aryl group, in one embodiment with at least about 5 carbon atoms, and in another embodiment with at least about 6 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges.

(iv) an arylalkyl group, including substituted and unsubstituted arylalkyl groups, wherein the alkyl portion of the arylalkyl group can be linear or branched, saturated or unsaturated, and cyclic or acyclic, and wherein heteroatoms either may or may not be present in either the aryl or the alkyl portion of the arylalkyl group, in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, or

(v) an alkylaryl group, including substituted and unsubstituted alkylaryl groups, wherein the alkyl portion of the alkylaryl group can be linear or branched, saturated or unsaturated, and cyclic or acyclic, and wherein heteroatoms either may or may not be present in either the aryl or the alkyl portion of the alkylaryl group, in one embodiment with at least about 6 carbon atoms, and in another embodiment with at least about 7 carbon atoms, and in one embodiment with no more than about 100 carbon atoms, in another embodiment with no more than about 60 carbon atoms, and in yet another embodiment with no more than about 30 carbon atoms, although the number of carbon atoms can be outside of these ranges, wherein the substituents on the substituted alkyl, aryl, arylalkyl, and alkylaryl groups can be (but are not limited to) halogen atoms, ether groups, aldehyde groups, ketone groups, ester groups, amide groups, carbonyl groups, thiocarbonyl groups, sulfate groups, sulfonate groups, sulfonic acid groups, sulfide groups, sulfoxide groups, phosphine groups, phosphonium groups, phosphate groups, nitrile groups, mercapto groups, nitro groups, nitroso groups, sulfone groups, acyl groups, acid anhydride groups, azide groups, azo groups, cyanato groups, isocyanato groups, thiocyanato groups, isothiocyanato groups, carboxylate groups, carboxylic acid groups, urethane groups, urea groups, mixtures thereof, and the like, wherein two or more substituents can be joined together to form a ring. In embodiments, the radiation curable phase change in herein comprises a gellant as described above and optionally a curable wax.

The ink compositions can include the gellant in any suitable amount, such as about 1% to about 50% by weight of the ink. In embodiments, the gellant can be present in an amount of about 2% to about 20% by weight of the ink, such as about 5% to about 15% by weight of the ink, although the value can also be outside of this range.

The curable wax may be any wax component that is miscible with the other components and that will polymerize with the curable monomer or oligomer to form a polymer. The term “wax” includes, for example, any of the various natural, modified natural, and synthetic materials commonly referred to as waxes A wax is solid at room temperature, specifically at 25° C. Inclusion of the wax promotes an increase in viscosity of the ink as it cools from the jetting temperature.

Suitable examples of curable waxes include, but are not limited to, those waxes that include or are functionalized with curable groups. The curable groups may include, for example, acrylate, methacrylate, alkene, allylic ether, epoxide, oxetane, and the like. These waxes can be synthesized by the reaction of a wax equipped with a transformable functional group, such as carboxylic acid or hydroxyl.

Suitable examples of hydroxyl-terminated polyethylene waxes that may be functionalized with a curable group include, but are not limited to, mixtures of carbon chains with the structure CH₃—(CH₂)ₙ—CH₂OH, where there is a mixture of chain lengths, n, where the average chain length can be in the range of about 16 to about 50, and linear low molecular weight polyethylene, of similar average chain length. Suitable examples of such waxes include, but are not limited to, the UNILIN® series of materials such as UNILIN® 350, UNILIN® 4N25, UNILIN® 550 and UNILIN® 700 with Mₙ approximately equal to 375, 460, 550 and 700 g/mol, respectively. All of these waxes are commercially available from Baker-Petrolite. Guerbet alcohols, characterized as 2,2-dialkyl-1-ethanols, are also suitable compounds. Exemplary Guerbet alcohols include those containing about 16 to about 36 carbons, many of which are commercially available from Jarchem Industries Inc., Newark, N.J. PRIPOL® 2033 (C-36 dimer diol mixture including isomers of the formula

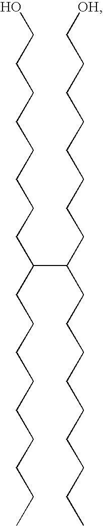

as well as other branched isomers that may include unsaturations and cyclic groups, available from Uniqema, New Castle, Del.; further information on C₃₆ dimer diols of this type is disclosed in, for example, “Dimer Acids,” Kirk-Othmer Encyclopedia of Chemical Technology, Vol. 8, 4^{th} Ed. (1992), pp. 223 to 237, the disclosure of which is totally incorporated herein by reference, can also be used. These alcohols can be reacted with carboxylic acids equipped with UV curable moieties to form reactive esters. Examples of these acids include acrylic and methacrylic acids, available from Sigma-Aldrich Co. In embodiments, suitable curable monomers include waxy acrylates, such as acrylates of UNILIN® 1350, UNILIN® 425, UNILIN® 550 and UNILIN® 700.

Suitable examples of carboxylic acid-terminated polyethylene waxes that may be functionalized with a curable group include mixtures of carbon chains with the structure CH₃—(CH₂)ₙ—COOH, where there is a mixture of chain lengths, n, where the average chain length is about 16 to about 50, and linear low molecular weight polyethylene, of similar average chain length. Suitable examples of such waxes include, but are not limited to, UNICID® 350, UNICID® 425, UNICID® 550 and UNICID® 700 with Mₙ equal to approximately 390, 475, 565 and 720 g/mol, respectively. Other suitable waxes have a structure CH₃—(CH₂)ₙ—COOH, such as hexadecanoic or palmitic acid with n=14, heptadecanoic or margaric or daturic acid with n=51, octadecanoic or stearic acid with n=16, eicosanoic or arachidic acid with n=18, docosanoic or behenic acid with n=20, tetracosanoic or lignoceric acid with n=22, hexacosanoic or cerotic acid with n=24, heptacosanoic or carboceric acid with n=25, octacosanoic or montanic acid with n=26, triacontanoic or melissic acid with n=28, dotriacontanoic or lacceroic acid with n=30, tritriacontanoic or ceromelissic or psyllic acid, with n=31, tetratriacontanoic or geddic acid with n=32, pentatriacontanoic or ceroplastic acid with n=33. Guerbet acids, characterized as 2,2-dialkyl ethanoic acids, are also suitable compounds. Exemplary Guerbet acids include those containing 16 to 36 carbons, many of which are commercially available from Jarchem Industries Inc., Newark, N.J. PRIPOL® 1009 (C-36 dimer acid mixture including isomers of the formula:

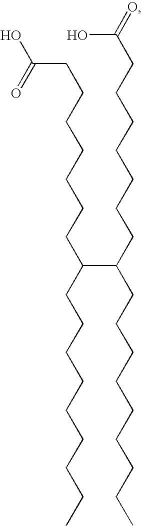

as well as other branched isomers that may include unsaturations and cyclic groups, available from Uniqema, New Castle, Del.

Further information on C₃₆ diner acids of this type is disclosed in, for example, “Dimer Acids,” Kirk-Othmer Encyclopedia of Chemical of Technology, Vol. 8, 4^{th} Ed. (1992), pp. 223 to 237, the disclosure of which is totally incorporated herein by reference, can also be used. These carboxylic acids can be reacted with alcohols equipped with UV curable moieties to form reactive esters. Examples of these alcohols include, but are not limited to, 2-allyloxyethanol from Sigma-Aldrich Co.;

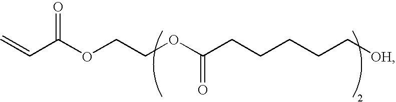

SR495B from Sartomer Company, Inc.;

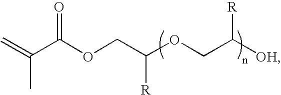

CD572 (R=H, n=10) and SR604 (R=Me, n=4) from Sartomer Company, Inc.

The curable wax can be included in the ink composition in an amount of from, for example, about 0 to about 25% by weight of the ink, such as about 1 or about 2 to about 10 or about 15% by weight of the ink. In an embodiment, the curable wax can be included in the ink composition in an amount of from about 3 to about 10% by weight of the ink, such as about 4 to about 6% by weight of the ink.

Any desired or effective colorant can be employed in the inks, including pigment, dye, mixtures of pigment and dye, mixtures of pigments, mixtures of dyes, and the like, provided that the colorant can be dissolved or dispersed in the ink vehicle. The compositions can be used in combination with conventional ink colorant materials, such as Color Index (C.I.) Solvent Dyes, Disperse Dyes, modified Acid and Direct Dyes, Basic Dyes, Sulphur Dyes, Vat Dyes, and the like.

Examples of suitable dyes include Usharect Blue 86 (Direct Blue 86), available from Ushanti Color; Intralite Turquoise 8GL (Direct Blue 86), available from Classic Dyestutffs; Chemictive Brilliant Red 7BH (Reactive Red 4), available from Chemiequip; Levafix Black EB, available from Bayer; Reactron Red H8B (Reactive Red 31), available from Atlas Dye-Chem; D&C Red #28 (Acid Red 92), available from Warner-Jenkinson; Direct Brilliant Pink B, available from Global Colors; Acid Tartrazine, available from Metrochem Industries; Cartasol Yellow 6GF Clariant; Carta Blue 2GL, available from Clariant; and the like. Particularly suitable are solvent dyes; within the class of solvent dyes, spirit soluble dyes are desired because of their compatibility within the ink vehicles of the present invention. Examples of suitable spirit solvent dyes include Neozapon Red 492 (BASF); Orasol Red G (Ciba); Direct Brilliant Pink B (Global Colors); Aizen Spilon Red C-BH (Hodogaya Chemical); Kayanol Red 3BL (Nippon Kayaku); Spirit Fast Yellow 3G; Aizen Spilon Yellow C-GNH (Hodogaya Chemical); Cartasol Brilliant Yellow 4GF (Clariant); Pergasol Yellow CGP (Ciba); Orasol Black RLP (Ciba); Savinyl Black RLS (Clariant); Morfast Black Conc. A (Rohm and Haas); Orasol Blue GN (Ciba); Savinyl Blue GLS (Sandoz); Luxol Fast Blue MBSN (Pylam); Sevron Blue 5GMF (Classic Dyestuffs); Basacid Blue 750 (BASF), and the like. Neozapon Black X51 [C.I. Solvent Black, C.I. 12195] (BASF), Sudan Blue 670 [C.I. 61554] (BASF), Sudan Yellow 146 [C.I. 12700] (BASF), and Sudan Red 462 [C.I. 260501] (BASF) are particularly suitable in embodiments.

Pigments are also suitable colorants for the inks. Examples of suitable pigments include Violet PALIOGEN Violet 5100 (BASF); PALIOGEN Violet 5890 (BASF); HELIOGEN Green L8730 (BASF); LITHOL Scarlet D3700 (BASF); Sunfast® Blue 15:4 (Sun Chemical 249-0592); Hostaperm Blue B2G-D (Clariant); Permanent Red P-F7RK; Hostaperm Violet BL (Clariant); LITHOL Scarlet 4440 (BASF); Bon Red C (Dominion Color Company); ORACET Pink RF (Ciba); PALIOGEN Red 3871 K (BASF); Sunfast® Blue 15:3 (Sun Chemical 249-1284); PALIOGEN Red 3340 (BASF); Sunfast® Carbazole Violet 23 (Sun Chemical 246-1670); LITHOL, Fast Scarlet L4300 (BASF); Sunbrite Yellow 17 (Sun Chemical 275-0023); HELIOGEN Blue L6900, L7020 (BASF); Sunbrite Yellow 74 (Sun Chemical 272-0558); Spectra Pac® C Orange 16 (Sun Chemical 276-3016); HELIOGEN Blue K6902, K6910 (BASF); Sunfast® Magenta 122 (Sun Chemical 228-0013); HELIOGEN Blue D6840, D7080 (BASF); Sudan Blue OS (BASF); NEOPEN Blue FF4012 (BASF); PV Fast Blue B2GO1 (Clariant); IRGALITE Blue BCA (Ciba); PALIOGEN Blue 6470 (BASF); Sudan Orange G (Aldrich), Sudan Orange 220 (BASF); PALIOGEN Orange 3040 (BASF); PALIOGEN Yellow 152, 1560 (BASF); LITHOL Fast Yellow 0991 K (BASF); PALIOTOL Yellow 1840 (BASF); NOVOPERM Yellow FGL (Clariant); Lumogen Yellow D0790 (BASF); Suco-Yellow L1250 (BASF); Suco-Yellow D1355 (BASF); Suco Fast Yellow D1 355, D1 351 (BASF); HOSTAPERM Pink E 02 (Clariant); Hansa Brilliant Yellow 5GX03 (Clariant); Permanent Yellow GRL 02 (Clariant); Permanent Rubine L6B 05 (Clariant); FANAL Pink D4830 (BASF); CINQUASIA Magenta (DU PONT), PALIOGEN Black L0084 (BASF); Pigment Black K801 (BASF); and carbon blacks such as REGAL 330™. (Cabot), Carbon Black 5250, Carbon Black 5750 (Columbia Chemical), mixtures thereof and the like.

The colorant can be included in the ink in any suitable amount, such as an amount of from about 0.1 to about 15% by weight of the ink, such as about 0.5 or about 1 to about 8 or about 10% by weight of the ink.

In embodiments, the composition further comprises an initiator, such as a photoinitiator, that initiates polymerization of curable components of the ink, including the curable monomer and the curable wax. The initiator should be soluble in the composition. In embodiments, the initiator is a UV-activated photoinitiator.

In embodiments, the initiator can be a radical initiator. Examples of radical photoinitiators include (but are not limited to) benzophenone derivatives, benzyl ketones, monomeric hydroxyl ketones, α-amino ketones, acyl phosphine oxides, metallocenes, benzoin ethers, benzil ketals, α-hydroxyalkylphenones, α-aminoalkylphenones, acylphosphine photoinitiators sold under the trade designations of IRGACURE® and DAROCUTR® from Ciba, isopropyl thioxanthenones, and the like, and mixtures and combinations thereof. Specific examples include 1-hydroxy-cyclohexylphenylketone, benzophenone, benzophenone derivatives, 2-benzyl-2-(dimethylamino)-1-(4-(4-morpholinyl)phenyl)-1-butanone, 2-methyl-1-(4-methylthio)phenyl-2-(4-morphorlinyl)-1-propanone, diphenyl-(2,4,6-trimethylbenzoyl) phosphine oxide, phenyl bis(2,4,6-trimethylbenzoyl) phosphine oxide, benzyl-dimethylketal, isopropylthioxanthone, 2,4,6-trimethylbenzoyldiphenylphosphine oxide (available as BASF LUCIRIN TPO®), 2,4,6-trimethylbenzoylethoxyphenylphosphine oxide (available as BASF LUCIRIN TPO-L®), bis(2,4,6-trimethylbenzoyl)-phenyl-phosphine oxide (available as Ciba IRGACURE® 819) and other acyl phosphines, 2-methyl-1-(4-methylthio)phenyl-2-(4-morphorlinyl)-1-propanone (available as Ciba IRGACURE® 907) and 1-(4-(2-hydroxyethoxy)phenyl)-2-hydroxy-2-methylpropan-1-one (available as Ciba IRGACURE® 2959), 2-benzyl 2-dimethylamino 1-(4-morpholinophenyl) butanone-1 (available as Ciba IRGACURE® 369), 2-hydroxy-1-(4-(4-(2-hydroxy-2-methylpropionyl)-benzyl)-phenyl)-2-methylpropan-1-one (available as Ciba IRGACURE® 127), 2-dimethylamino-2-(4-methylbenzyl)-1-(4-morpholin-4-ylphenyl)-butanone (available as Ciba IRGACURE® 379), titanocenes, isopropylthioxanthenones, 1-hydroxy-cyclohexylphenylketone, benzophenone, 2,4,6-trimethylbenzophenone, 4-methylbenzophenone, diphenyl-(2,4,6-trimethylbenzoyl phosphine oxide, 2,4,6-trimethylbenzoylphenylphosphinic acid ethyl ester, oligo(2-hydroxy-2-methyl-1-(4-(1-methylvinyl)phenyl) propanone), 2-hydroxy-2-methyl-1-phenyl-1-propanone, benzyl-dimethylketal, and the like, as well as mixtures thereof. In an embodiment, the ink contains an α-amino ketone, such as, for example, IRGACURE® 379 (Ciba Specialty Chemicals), 2-hydroxy-1-(4-(4-(2-hydroxy-2-methylpropionyl)-benzyl)-phenyl)-2-methylpropan-1-one, such as, for example, IRGACURE®F) 127 (Ciba Specialty Chemicals), bis(2,4,6-trimethylbenzoyl)-phenylphosphineoxide, such as, for example, IRGACURE® 819 and 2-isopropyl-9H-thioxanthen-9-one, such as, for example, DAROCUR® ITX (Ciba Specialty Chemicals).

In other embodiments, the initiator can be a cationic initiator. Examples of suitable cationic photoinitiators include aryldiazonium salts, diaryliodonium salts, triarysulfonium salts, triarylselenonium salts, dialkylphenacylsulfonium salts, triarylsulphoxonium salts and aryloxydiarylsulfonium salts.

The total amount of initiator included in the ink may be, for example, about 0.5 to about 15%, such as about 1 to about 10%, by weight of the ink.

The ink may contain optional additives. Optional additives include, but are not limited to, surfactants, light stabilizers, UV absorbers, which absorb incident UV radiation and convert it to heat energy that is ultimately dissipated, antioxidants, optical brighteners, which can improve the appearance of the image and mask yellowing, thixotropic agents, dewetting agents, slip agents, foaming agents, antifoaming agents, flow agents, other non-curable waxes, oils, plasticizers, binders, electrical conductive agents, fungicides, bactericides, organic and/or inorganic filler particles, leveling agents, e.g., agents that create or reduce different gloss levels, opacifiers, antistatic agents, dispersants, and the like. In particular, the composition may include, as a stabilizer, a radical scavenger, such as Irgastab UV 10 (Ciba Specialty Chemicals, Inc.). The composition may also include an inhibitor, such as a hydroquinone, to stabilize the composition by prohibiting or, at least, delaying, polymerization of the oligomer and monomer components during storage, thus increasing the shelf life of the composition. However, additives may negatively affect cure rate, and thus care must be taken when formulating a composition using optional additives.

The total amount of other additives included in the ink may be, for example, about 0.5 to about 15%, such as about 1 to about 10%, by weight of the ink.

In embodiments, the ink has a viscosity of from 8 cP to 15 cP, such as from 10 cP to 12 cP, at a temperature between 60° C. and 100° C. In embodiments, the ink has a viscosity of from 10⁵ to 10⁷ cP at a temperature of 50° C. or below, specifically at a temperature from 0° C. to 50° C.

The inks described herein can be jetted at any suitable temperature. However, in embodiments, the inks are jetted at temperatures of less than about 110° C., such as about 40° C. to about 110° C., or about 65° C. to about 100° C. The inks are thus ideally suited for use in piezoelectric ink jet devices.

The inks described herein may be applied to a substrate to form an image. In embodiments, the method comprises providing a radiation curable ink described herein; applying the radiation curable ink to the substrate to form an image; and exposing the radiation curable ink to radiation to cure the ink. During the curing process, the curable monomer and the curable wax, optionally with other curable components, are polymerized to form a cured image.

The inks can be employed in apparatus for direct printing ink jet processes, wherein when droplets of the melted ink are ejected in an imagewise pattern onto a recording substrate, the recording substrate is a final recording substrate. Alternatively, the inks can be employed in indirect (offset) printing ink jet applications, wherein when droplets of the melted ink are ejected in an imagewise pattern onto a recording substrate, the recording substrate is an intermediate transfer member and the ink in the imagewise pattern is subsequently transferred from the intermediate transfer member to a final recording substrate.

The substrate may be any suitable material such as paper, boxboard, cardboard, fabric, a transparency, plastic, glass, wood etc., although the ink is desirably used in forming images on paper. Following transfer to the substrate, the image on the substrate is exposed to radiation having an appropriate wavelength, mainly the wavelength at which the ink initiator absorbs radiation, to initiate the curing reaction of the ink. The radiation exposure need not be long, and may be for, e.g., about 0.05 to about 10 seconds, more such as about 0.2 to about 5 seconds. These exposure times are more often expressed as substrate speeds of the ink passing under a UV lamp. For example, the microwave energized, doped mercury bulbs available from UV Fusion (Gaithersburg, Md.) are placed in an elliptical mirror assembly that is 10 cm wide, multiple units may be placed in series. Thus, a belt speed of 0.1 ms⁻¹ would require 1 second for a point of an image to pass under a single unit, while a belt speed 4.0 ms⁻¹ would require 0.2 s to pass under four bulb assemblies. The radiation to cure the polymerizable components of the ink can, for example, be provided by a variety of possible techniques, including hut not limited to a xenon lamp, laser light, D or H bulb, etc. The curing light may be filtered, if desired or necessary. The curable components of the ink react to form a cured or crosslinked network of appropriate hardness. In embodiments, the curing is substantially complete, i.e., at least 75% of the curable components are cured (polymerized and/or crosslinked), to allow the ink to be substantially hardened, and thereby to be much more scratch resistant, and also to adequately control the amount of showthrough on the substrate.

The present disclosure is also directed to a printer containing the inks described herein. Specifically, the present disclosure relates to a printer cartridge containing the inks described herein, as well as to a printer containing the printer cartridge.

The present disclosure also relates to a method for applying the ink to form an image. In embodiments, the method comprises providing the ink at or above the first temperature; applying the ink to a substrate to form an image, the substrate being at or below the second temperature. Where the ink is radiation curable, the method preferably further comprises exposing the ink to radiation to cure the ink. In a preferred embodiment, the composition is applied over the image by ink jet printing.

Examples are set forth hereinbelow and are illustrative of different compositions and conditions that can be utilized in practicing the disclosure. All proportions are by weight unless otherwise indicated. It will be apparent, however, that the disclosure can be practiced with many types of compositions and can have many different uses in accordance with the disclosure above and as pointed out hereinafter.

### EXAMPLES

Eight ink formulations were prepared as shown in Table 1. The inks were formulated as follows: the amide gellant, Unilin 350-acrylate (optionally, prefiltered to 2 μm) and SR9003 were stirred at 90° C. for 2 h, after which time the solutions were filtered to 0.22 μm at 85° C. The solutions were allowed to solidify at room temperature overnight and then were refiltered to 0.22 μm at 85° C. To these solutions were added the photoinitator package and the resulting ink base was stirred at 90° C. for 1 h. The bases were filtered to 0.22 μm at 85° C. The resulting solutions were added to stirring solution of pigment dispersion, also at 90° C., and the resulting ink was stirred for 2 h at 90° C. All inks were filtered to 6 μm at 85° C.

TABLE 1
Ink Formulations

| | Ink, wt % | | | | | | | |
|---|---|---|---|---|---|---|---|---|
| | Ink | Ink | Ink | Ink | Ink | Ink | Ink | Ink |
| | No. 1 | No. 2 | No. 3 | No. 4 | No. 5 | No. 6 | No. 7 | No. 8 |
| Component | Cyan | Magenta | Yellow | Black | Cyan | Magenta | Yellow | Black |
| Amide | 7.5 | 7.5 | 7.5 | 7.5 | 7.5 | 7.5 | 7.5 | 7.5 |
| gellant | | | | | | | | |
| Unilin 350- | — | — | — | — | 5.0 | 5.0 | 5.0 | 5.0 |
| acrylate | | | | | | | | |
| SR9003 | 70.8 | 63.8 | 68.5 | 71.5 | 65.8 | 58.8 | 63.5 | 66.5 |
| Irgacure | 3.0 | 3.0 | 3.0 | 3.0 | 3.0 | 3.0 | 3.0 | 3.0 |
| 379 | | | | | | | | |
| Darocur | 2.0 | 2.0 | 2.0 | 2.0 | 2.0 | 2.0 | 2.0 | 2.0 |
| ITX | | | | | | | | |
| Irgacure | 1.0 | 1.0 | 1.0 | 1.0 | 1.0 | 1.0 | 1.0 | 1.0 |
| 819 | | | | | | | | |
| Irgacure | 3.5 | 3.5 | 3.5 | 3.5 | 3.5 | 3.5 | 3.5 | 3.5 |
| 127 | | | | | | | | |
| Irgastab | 0.2 | 0.2 | 0.2 | 0.2 | 0.2 | 0.2 | 0.2 | 0.2 |
| UV10 | | | | | | | | |
| Sun cyan | 12.0 | | | | 12.0 | | | |
| dispersion, | | | | | | | | |
| 25 wt % | | | | | | | | |
| Sun | | 14.3 | | | | 14.3 | | |
| magenta | | | | | | | | |
| pigment | | | | | | | | |
| dispersion, | | | | | | | | |
| 21 wt % | | | | | | | | |
| Sun yellow | | | 19.0 | | | | 19.0 | |
| pigment | | | | | | | | |
| dispersion, | | | | | | | | |
| 16 wt % | | | | | | | | |
| Sun black | | | | 11.3 | | | | 11.3 |
| pigment | | | | | | | | |
| dispersion, | | | | | | | | |
| 26.5 wt % | | | | | | | | |

The inks were printed between 80 and 85° C. on a PHASER® 860 printer (modified to change the intermediate transfer drum temperature, paper preheating temperature, and ink heating temperature) directly onto paper attached to an intermediate transfer member at 30° C. and then exposed to UV light at a remote curing station or from an in-line source. The inks were printed on Xerox® 4024, Hammermill® (International Paper), Xerox® Digital Color Gloss and Pasadena Litho Label papers. All gloss measurements were made on a micro-TRI-gloss meter from BYK Gardner at 60°.

Table 2 provides the gloss measurements of the eight different inks on Xerox® 4024 plain paper when measured at 60°. Table 3 provides the gloss measurements of the eight different inks on Hammermill plain paper when measured at 60°. Table 4 provides the gloss measurements of the eight different inks on Xerox Digital Color Gloss paper when measured at 60°. Table 5 provides the gloss measurements of five different inks on Pasadena Litho Label paper when measured at 60°.

TABLE 2
Gloss measurements on Xerox ® 4024 plain paper at 60°

| | Average Gloss at 60° (ggu) | | |
|---|---|---|---|
| | | | Gloss Difference |
| Ink Number | Image | Paper | (Image − Paper) |
| 1 | 5.6 | 4.5 | 1.1 |
| 2 | 7.1 | 5.4 | 1.7 |
| 3 | 7.0 | 4.2 | 2.8 |
| 4 | 8.1 | 4.2 | 3.9 |
| 5 | 6.6 | 4.7 | 1.9 |
| 6 | 7.9 | 4.4 | 3.6 |
| 7 | 9.0 | 4.3 | 4.7 |
| 8 | 6.4 | 4.8 | 1.6 |

TABLE 3
Gloss Measurements on Hammermill plain paper at 60°

| | Average Gloss at 60° (ggu) | | |
|---|---|---|---|
| | | | Gloss Difference |
| Ink Number | Image | Paper | (Image − Paper) |
| 1 | 8.8 | 5.0 | 3.8 |
| 2 | 8.4 | 4.4 | 3.9 |
| 3 | 6.4 | 4.8 | 1.6 |
| 4 | 4.0 | 4.8 | −0.8 |
| 5 | 7.6 | 4.9 | 2.7 |
| 6 | 7.4 | 5.0 | 2.6 |
| 7 | 7.8 | 4.8 | 3.0 |
| 8 | 8.4 | 4.4 | 3.9 |

TABLE 4
Gloss Measurement on Xerox Digital Color Coated paper at 60°

| | Average Gloss at 60° (ggu) | | |
|---|---|---|---|
| | | | Gloss Difference |
| Ink Number | Image | Paper | (Image − Paper) |
| 1 | 44.1 | 31.4 | 12.6 |
| 2 | 51.2 | 28.8 | 23.1 |
| 3 | 47.8 | 28.8 | 19.0 |
| 4 | 24.4 | 28.8 | −4.4 |
| 5 | 57.3 | 33.3 | 24.0 |
| 6 | 18.6 | 30.7 | −12.1 |
| 7 | 15.8 | 30.6 | −14.8 |
| 8 | 10.2 | 30.4 | −20.2 |

TABLE 5
Gloss Measurement on Pasadena Litho Label Coated paper
at 60°

| | Average Gloss at 60° (ggu) | | |
|---|---|---|---|
| | | | Gloss Difference |
| Ink Number | Image | Paper | (Image Paper) |
| 1 | 39.0 | 26.6 | 12.6 |
| 4 | 17.9 | 24.8 | −6.9 |
| 6 | 22.1 | 25.4 | −3.3 |
| 7 | 19.8 | 26.3 | −6.5 |
| 8 | 16.1 | 25.3 | −9.2 |

What is claimed is:

1. A curable ink that possesses a characteristic that when the ink is printed and cured on a substrate, gloss of printed areas of the substrate closely matches gloss of unprinted areas of the substrate.

2. The curable ink according to claim 1, wherein the gloss of printed areas of the substrate exceeds gloss of unprinted areas of the substrate.

3. The curable ink according to claim 1, wherein the gloss of printed areas of the substrate is less than gloss of unprinted areas of the substrate.

4. The curable ink according to claim 1, wherein when the ink is printed and cured on plain paper, a gloss value of printed areas of the substrate and a gloss value of unprinted areas of the substrate are within about 5 ggu when measured at 60°.

5. The curable ink according to claim 1, wherein when the ink is printed and cured on plain paper a gloss value of printed areas of the substrate and a gloss value of unprinted areas of the substrate are within about 4 ggu when measured at 60°.

6. The curable ink according to claim 1, wherein when the ink is printed and cured on plain paper, a gloss value of printed areas of the substrate and a gloss value of unprinted areas of the substrate are within about 3 ggu when measured at 60°.

7. The curable ink according to claim 1, wherein when the ink is printed and cured on plain paper, a gloss value of printed areas of the substrate and a gloss value of unprinted areas of the substrate are within about 2 ggu when measured at 60°.

8. The curable ink according to claim 1, wherein when the ink is printed and cured on plain paper, a gloss value of printed areas of the substrate and a gloss value of unprinted areas of the substrate are within about 1 ggu when measured at 60°.

9. The curable ink according to claim 1, wherein when the ink is printed and cured on coated paper, a gloss value of printed areas of the substrate and a gloss value of unprinted areas of the substrate are within about 25 ggu when measured at 60°.

10. The curable ink according to claim 1, wherein when the ink is printed and cured on coated paper, a gloss value of printed areas of the substrate and a gloss value of unprinted areas of the substrate are within about 20 eau when measured at 60°.

11. The curable ink according to claim 1, wherein when the ink is printed and cured on coated paper, a gloss value of printed areas of the substrate and a gloss value of unprinted areas of the substrate are within about 18 ggu when measured at 60°.

12. The curable ink according to claim 1, wherein when the ink is printed and cured on coated paper, a gloss value of printed areas of the substrate and a gloss value of unprinted areas of the substrate are within about 15 ggu when measured at 60°.

13. The curable ink according to claim 1, wherein when the ink is printed and cured on coated paper, a gloss value of printed areas of the substrate and a gloss value of unprinted areas of the substrate are within about 10 ggu when measured at 60°.

14. The curable ink according to claim 1, wherein when the ink is printed and cured on coated paper, a gloss value of printed areas of the substrate and a gloss value of unprinted areas of the substrate are within about 5 ggu when measured at 60°.

15. The curable ink according to claim 1, the ink comprising:
a curable monomer or oligomer;
a gellant;
a colorant; and
and at least one initiator.

16. The curable ink according to claim 15, comprising about 20 to about 90% by weight of the curable monomer or oligomer, about 1 to about 25% by weight of the gellant, and about 0.1 to about 15% by weight of the colorant, all by weight of the ink.

17. The curable ink according to claim 16, comprising about 40 to about 80% by weight of the curable monomer or oligomer, about 8 to about 9% by weight of the gel ant and about 1 to about 8% by weight of the colorant, all by weight of the ink.

18. A method for forming an image, said method comprising:
applying the curable ink according to claim 1 to a substrate in an imagewise manner; and
exposing the curable ink to radiation to cure the ink.

19. The method according to claim 18, wherein said curable ink is applied to the substrate by ink jet printing.

20. The method according to claim 18, wherein said radiation is ultra-violet light.

21. A printer cartridge comprising the curable ink according to claim 1.

22. A printer comprising a printer cartridge according to claim 21.
